(19) United States
(12) Patent Application Publication
(10) Pub. No.: US 2015/0212041 A1
(43) Pub. Date: Jul. 30, 2015

(54) USE OF A REFERENCE SYSTEM FOR ELECTROCHEMICAL ANALYSIS AND DEPOSITION METHODS

(71) Applicant: ancosys GmbH, Pliezhausen (DE)

(72) Inventor: Juerg Stahl, Winterthur (CH)

(21) Appl. No.: 14/417,539

(22) PCT Filed: Jul. 10, 2013
(86) PCT No.: PCT/EP2013/064568

§ 371 Date: Jan. 26, 2015

(30) Foreign Application Priority Data
Jul. 27, 2012 (DE) 102012106831.3

(51) Int. Cl. G01N 27/416; G01N 27/30

(52) U.S. Cl. CPC G01N 27/4165; G01N 27/301

(57) ABSTRACT

Use of a reference system for electrochemical analysis and deposition methods, in which analysis or deposition methods at least one operating electrode (21), a mating electrode (23) and a reference electrode (22) are used, wherein the reference electrode (22) is a pH electrode (10) that has an impermeable membrane (12), and an input amplifier V1 (16) for the pH electrode (10) having a high input impedance is provided, and supplies the signal from the pH electrode (10) to the input amplifier V1 (16) via a cable, and a further amplifier V2 (17) is provided, which is used to compensate for the disadvantageous effects of the screening and of the cable and of the test setup, or the amplifier V1 (16) is integrated in the pH electrode (10) as an impedance converter, or the amplifier V1 (16) is integrated in the connector of the pH electrode as an impedance converter.

The present invention relates to the use of a reference system for electrochemical analysis and deposition methods, at least one working electrode, one counter electrode and one reference electrode being used in the method.

In electrochemical analysis, methods in which a reference system is employed are frequently used.

Such analysis methods are, for example, steady-state methods such as current density/potential measurement, potentiostatic measurement and galvanostatic measurement, potential sweep methods such as liner sweep voltammetry LSV, cyclic voltammetry (cyclovoltammetry) CV, triangular voltage methods (cyclovoltammetry stripping) CVS and polarography, transient methods such as chronoamperometry CA, chronopotentiometry CP, chronocoulometry CC and combination methods such as spectroelectrochemistry SEC or electrochemical quartz crystal microbalance EQCM, and position-resolved methods such as the scanning reference electrode technique SRET and scanning electrochemical microscope SECM, AC methods such as electrochemical impedance spectroscopy EIS, or methods without external excitation, such as open circuit potential OCP measurement and electrochemical noise ECN.

For certain analytical tasks, two or more methods may be combined to form a single method.

Furthermore, reference electrodes are also used in electrochemical production methods, such as conventional coating technology, and the semiconductor industry and printed circuit board technology.

In the semiconductor industry and printed circuit board manufacture, coating methods with rapid changes (less than 200 ms, or 100 ms) are also used. For instance, the pulse plating method operates with pulses <100 ms. Also in the so-called hot entry method, in which the product to be coated is introduced in a controlled way, the processes take place in less than 100 ms. The nucleation, which is crucial for the quality of a layer, takes place in less than 50 ms.

The most widespread reference electrodes include electrodes of the second type, the potential of which depends only indirectly on the concentration of the electrolyte solution surrounding them. Important electrodes of the second type are the silver/silver chloride electrode and the calomel electrode. The equilibrium potential of the electrode is in this case determined by the solubility product of the base body (for example hardly soluble salt or oxide). They are used, for example, in potentiometry.

The reference systems are used in order to provide a stable reference potential in a liquid.

One requirement of these systems is that the electrode potential should remain unchanged in the event of small current transits.

Furthermore, the impedance of the reference electrode must be as low as possible.

Of course, the liquid to be studied also must not be contaminated or influenced by the reference system, since this would lead to vitiation of the measurement result.

The known reference systems establish the electrical contact with the external fluid by means of an internal electrolyte (accurately concentrated alkali metal salt solution with the same anion as the hardly soluble salt) via a diaphragm.

The selection of a compatible internal electrolyte for the known reference systems is difficult, since the internal electrolyte should be compatible both with the liquid to be measured and with the hardly soluble salt of the reference electrode, and furthermore also must not negatively influence the measurements.

A suboptimal selection of the internal electrolyte can lead to the electrical contact between the reference electrode and the internal electrolyte being broken. Another disadvantage of the known reference systems is that the electrodes are maintenance-intensive, since the internal or bridging electrolyte has to be topped up regularly. Often, during maintenance, electrolytes are also mixed up or contaminated solutions are used, a further source of error which in turn leads to a shift of the reference potential and therefore to false measurements.

The diaphragm of the internal electrolyte may also become unusable, for example when the liquid to be studied forms deposits on/in the diaphragm.

In order to avoid the difficulties associated with diaphragms, DE 197 48 052 A1 proposes a bridging body for an electrode, in which case the electrode may be connected to a high-impedance input of an operational amplifier. In this potentiometric circuit, a measurement electrode is used, and the electrode with the bridging body forms the counter electrode.

The use of reference electrodes, which are constructed with mercury and mercury salts, is becoming increasingly restricted for reasons of environmental protection.

In the laboratory field, all these difficulties can still be overcome. For applications in online analysis and in production methods, however, the long-term stability of a reference system is extremely important since there is in this case no intermediate user or laboratory technician, and without external intervention it is not possible to establish whether the potential of the reference electrode has changed and the overall measurement result is therefore vitiated.

It is an object of the present invention to provide a reference system for electrochemical analysis and deposition methods, in which methods a reference electrode is also used in addition to a working electrode and a counter electrode, in which case the reference system should have the desired long-term stability, be usable in online analysis even for rapid measurements, and furthermore be maintenance-friendly.

This object is achieved by a reference system in which a pH electrode with an impermeable membrane is used as a reference electrode, and in which an input amplifier V1 with a high input impedance is provided for the pH electrode, and in which

(i) in a first alternative, either the electrode signal is delivered to the input amplifier V1 via a cable and a further amplifier V2 is provided, which is used to compensate for the detrimental effects of the guarding, of the cable and/or of the measurement layout, or
(ii) in a second alternative, the amplifier V1 is integrated as an impedance converter into the pH electrode, in which case a further amplifier V2 may be provided, which is used to compensate for the detrimental effects of the guarding of the pH electrode, into which the pH electrode is integrated, or
(iii) in a third alternative, the amplifier V1 is integrated as an impedance converter into the jack of the pH electrode, in which case a further amplifier V2 may be provided, which is used to compensate for the detrimental effects of the guarding of the pH electrode.

By the use of a pH electrode in which the internal electrolyte is separated from the measurement solution by a membrane, which is impermeable for the measurement solution, any exchange of ions between the measurement solution and the internal electrolyte is prevented, so that undesired changes of the reference potential due to contamination or concentration changes of the internal electrolyte are avoided.

Since only a potential has been built up on the impermeable membrane, but no particles pass through, the contaminations of the measurement solutions, which are known for an electrode of the second type, and the observed deposits on/in the diaphragm, which likewise entail undesired potential changes, also do not occur.

The membrane is preferably a glass membrane.

The pH electrode is preferably a glass or enamel electrode.

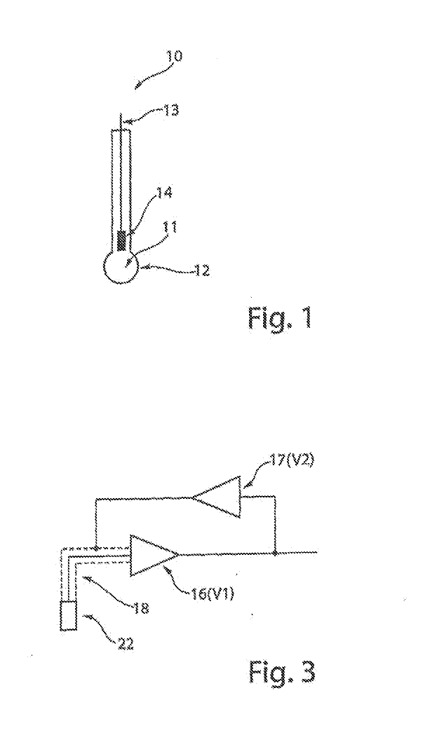

A glass electrode 10 in the context of the present invention is intended to mean a (single) glass electrode consisting of a lead-off system 14, an electrical terminal 13, an internal buffer/electrolyte 11 and a glass membrane 12 (cf. FIG. 1) and not a combined glass electrode, that is to say a monobloc measurement unit with a reference electrode. In the glass electrode, the internal buffer/electrolyte is in conductive connection with the measurement solution, at which the potential is formed. The sodium or lithium ions contained in the glass membrane are relatively freely mobile, while the membrane is impermeable for hydrogen ions.

Tests have furthermore shown that pH electrodes are stable over a long time without any maintenance. The deviations were less than 5 mV, which was not achieved with conventional electrodes of the second type Ag/AgCl.

Another advantage of the pH electrode with an impermeable membrane is that the equilibrium at the membrane is perturbed in the event of system perturbations due to large voltage differences or current flows, and false measurement values are clearly displayed. The user therefore has a way of monitoring when the pH electrode is not fit for use. In the case of the known reference electrodes, however, in particular electrodes of the second type, in the event of large voltage differences and current flows only creeping, slowly varying potential changes occur, which are often not noticed by the user and measurement will therefore continue with a defective electrode.

Another advantage of the pH electrode is that, after a certain period of time and suitable storage, it recovers even after large voltage differences or current flows, and is therefore not permanently damaged.

By way of example, an enamel electrode may likewise be used as a pH electrode, since it likewise has an impermeable membrane through which no ion transit occurs.

Owing to the pH dependency of the pH electrode, it is necessary to know the pH of the liquid to be measured or controlled, or in the case of relative measurements to work in systems with a pH which is constant or varies in a known way.

In the case of a glass pH electrode, the potential measured (against hydrogen 0) is the sum of the potential which is formed at the glass membrane owing to the pH difference between the internal electrolyte and the product to be measured, and the potential which is formed by the lead-off system. A commercially available glass pH electrode has an internal buffer of pH 7 and an Ag/AgCl lead-off system.

Another advantage of the reference system according to the invention is that, for a particular pH, the reference system can be adjusted by suitable selection of the internal buffer in such a way that the temperature dependence in the Nernst equation is compensated for. Thus, measurement errors due to temperature changes can be eliminated without additional temperature control.

The Nernst equation, applied to a pH-sensitive membrane, reads as follows:

U_{pH}=(R*T)/F*ln(Cₓ/C₀) (1)

R=8.31447 Jmol⁻¹K⁻¹, the gas constant, T=temperature [K], F=Faraday's constant 96485.3 J V⁻¹mol⁻¹.

If the equation is rearranged, then the following is obtained:

Uₚₕ=0.198*T*(pH₀−pHₓ)[mV] (2)

pH₀=pH value of the internal buffer, pHₓ=pH value of the measurement solution.

From the equation above, it follows that the glass membrane has a temperature excursion of 0.198 mV per ° C. and per pH difference between H⁺ concentration of product to be measured and internal buffer. The temperature excursion for the glass membrane is represented in FIG. 2, curve b.

For the Ag/AgCl lead-off system, on the other hand, the Nernst equation reads:

U_{A}=U₀+(R*T)/F*ln(Cₓ/C₀) (3)

with U₀=standard electron potential.

Accurate calculation of the temperature dependency of the lead-off system is not exactly possible. Measurements of lead-off systems in practice have given a temperature excursion of −0.7 mV per ° C., cf. curve a in FIG. 2.

Since the temperature excursion of pH membrane is positive and the temperature excursion of the Ag/AgCl lead-off system is negative, the temperature dependency of the reference electrode can be eliminated by suitable selection of the internal buffer.

The measurement voltage is the sum of the voltage which is formed at the pH membrane and the voltage of the lead-off system (cf. FIG. 2c).

If the internal buffer is selected at 3.5 pH units above the value of the product to be measured, then the temperature dependency of the pH membrane is:

U_{pH}=0.198*T*(pH₀−pHₓ)=T*0.198*3.5=T*0.693 [mV] (4)

Even if the pH has a variation of ±1 pH, there is a temperature dependency of at most ±0.2 mV/° C. In most applications, therefore, a temperature measurement for the reference electrode compensation can be obviated.

The impedances of pH electrodes typically lie between 5*10⁶Ω and 1*10⁹Ω, and therefore orders of magnitude greater than the impedances of the electrodes of the second type, which are between 1*10³Ω and 0.1*10⁶Ω. For a stable measurement layout, guarding of the measurement system is necessary in order to prevent interference from outside and to ensure reliable measurements. Owing to the structure of guarding, stray capacitors are formed which may amount to a few hundred picofarads. These stray capacitors form, together with the impedance of the pH electrode, a low-pass filter which significantly delays the measurement signal.

The effect of this is that pH electrodes can only be used to observe or control slow or statistical processes which take place in the range of seconds.

In order to ensure the desired long-term stability of the potential and to be able to use the reference system for rapid online measurements as well, in particular dynamic measurements with sweeps or pulses, according to the invention it is furthermore necessary to provide an input amplifier V1 for the reference electrode with a high input impedance and to provide a further amplifier V2, which compensates for the effects of the guarding and the measurement layout.

In the context of the present invention, an amplifier V1 is intended to mean any component or a group of components with a high input impedance for the reference electrode, and the further amplifier V2 is intended to mean any component or a group of components which compensates or substantially compensates for the effects of the guarding, of the cable and/or of the measurement layout. The amplifiers V1 and V2 may also be amplified with one amplifier.

Typically, input impedances of the input amplifier V1 of at least 10¹¹Ω and preferably more than 10¹²Ω are necessary in order to avoid a load on the voltage source which lead to vitiation of the voltage measurement.

Suitable input amplifiers V1 require an input current which is less than 10 pA, preferably less than 1 pA, and particularly preferably less than 200 fA. This allows exact measurement of the potential with a pH electrode having an impedance of 1*10⁹Ω.

Guarding is intended to mean any measure which prevents input or emission of electrical signals on the signal of the reference electrode. This includes in particular cables, the lead-off system in the reference electrode, connecting jacks, conductive tracks on the printed circuit board, and the housing.

Any capacitive load, which are due to the design of the reference electrode and the associated measurement layout, have a detrimental effect on the measurement of rapid processes. The high impedance of a reference electrode with an impermeable membrane forms, with any stray capacitance, a low-pass filter which delays the measurement signal. The impedance of a reference electrode with an impermeable membrane typically has a value of from a few 10⁶ ohms to 1*10⁹ ohms. If the stray capacitances together amount to 100 pF, and if the impedance of the reference electrode is 100*10⁶ ohm, then the delay time is 50 ms. Typically, the leads to the measurement amplifier V1 are to be shielded. The guarding is necessary in order to ensure that no interference signals are coupled into the measurement signal. The coaxial cables typically used in practice have a capacitive load of from 50 pF/m to 100 pF/m. This capacitive loading by the lead cable is generally more than 50% of the overall stray loading of the measurement signal. If the reference electrode comprises guarding of the lead-off system, then this typically also has a stray capacitance of up to 30 pF. The jacks and printed circuit boards used, as well as the amplifier V1, also have stray capacitances, which are generally <10 pF.

In order to make measurements with signal profiles <200 ms reliable, as far as possible all stray capacitances which a measurement layout comprises should be compensated for. This includes, in particular, the measurement cable and the guarding of the lead-off system in the reference electrode. The circuit used, consisting of V1 and V2, is capable of eliminating the negative effect of the stray capacitance and nevertheless ensuring effective guarding. Normally, the guarding (cables, lead-off system and printed circuit board) is connected to the ground or chassis of the measuring system. That is to say, all stray capacitances have to be charged to the voltage potential of the reference electrode. The required current, which is necessary for charging the capacitances, causes a voltage drop across the internal resistance of the reference electrode. The measured voltage is always less than the voltage generated by the reference electrode, so long as a current which is required for charging the stray capacitors of the guarding flows. This charging process can be eliminated when the guarding is connected to the output of the amplifier V2. In this way, the voltage difference between the measurement signal and the guarding is kept at almost 0 V. No current therefore flows, and no voltage drop occurs across the internal resistance of the reference electrode. A prerequisite for this type of compensation for the stray capacitances is that the voltage at the guarding and of the measurement signal have the least possible time delay.

Preferably, the cutoff frequency of the input amplifier V1 should be more than 1 MHz, preferably more than 3.5 MHz, and particularly preferably more than 25 MHz.

The further amplifier V2 must be capable of driving the capacitive load of the guarding without vitiating the signal.

The potential must not be vitiated by capacitive charge redistribution on the leads of the electrode and inside the measurement amplifier. This is prevented by keeping the potential of the guarding with a low impedance at exactly the same potential as the high-impedance signal of the pH electrode.

The further amplifier V2 should have a cutoff frequency of at least 1 MHz, preferably at least 3.5 MHz, and particularly preferably at least 25 MHz, and be able to drive a capacitive load of at least 10 pF, preferably at least 100 pF, and particularly preferably more than 1 nF.

In another variant, the amplifier V1 is built directly into the pH electrode. In this case, the amplifier V2 can be obviated so long as the pH electrode has no guarding.

Likewise, the amplifier V2 can be obviated so long as the amplifier V1 is built into the jack of the pH electrode and the pH electrode has no guarding.

Particularly good results have been achieved with glass pH electrodes having integrated amplifiers and guarding of the lead-off system.

Ion-sensitive field-effect transistors are likewise suitable (ISFET electrodes or REFET electrodes).

Since in most of the applications mentioned above the pH of the liquid to be measured remains approximately constant during the measurement, the potential of the electrode described here is also influenced only negligibly during the measurement.

In online measurements and production methods, the pH values are very stable since the process windows usually have a bandwidth of ±<0.1 pH. This would correspond to a reference potential variation of ±5.9 mV, which is to be expected even in a conventional reference system. If larger variations are to be expected, it is necessary to know the pH and correct accordingly to a defined value. Very often, the concentration of the substance determining the pH is measured and readjusted in the course of the process monitoring.

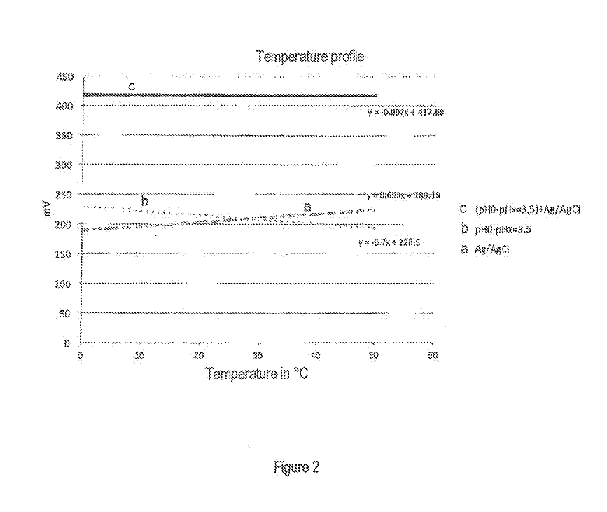

FIG. 3 represents, in a simplified way, the reference system according to the invention, which comprises the reference electrode 22, a pH electrode, the input amplifier 16 (V1) (gain: 1×), the further amplifier 17 (V2) (gain: 1×) and the guarding 18. The input amplifier 16 (V1) (impedance converter) has an input current of less than 1 pA, preferably less than 200 fA. This allows exact measurement of the potential with a pH electrode having an impedance of 1*10⁹Ω. The amplifier 16 (V1) should also still have a cutoff frequency of more than 3.5 MHz, preferably more than 25 MHz.

The further amplifier 17 (V2) is a guard amplifier, which compensates for the stray effects of the guarding. The guarding is represented in a simplified way. The guarding may comprise the following parts: the cable, the jacks, the printed circuit board, the amplifier housing and the shaft of the electrode. This makes it possible to measure even rapid potential changes.

The further amplifier 17 (V2) must be capable of driving the capacitive load of the guarding. The amplifier 17 (V2) should have a cutoff frequency of more than 3.5 Mhz and preferably more than 25 MHz and be capable of driving a capacitive load of more than 100 pF, preferably more than 1 nF.

The amplifiers 16 (V1) and 17 (V2) may also be embodied with one amplifier. The stray capacitances due to the layout, which cannot be compensated for by the guard circuit, i.e. the amplifier 16 (V1), the amplifier 17 (V2) and the guarding, should amount to less than 1% of the capacitance.

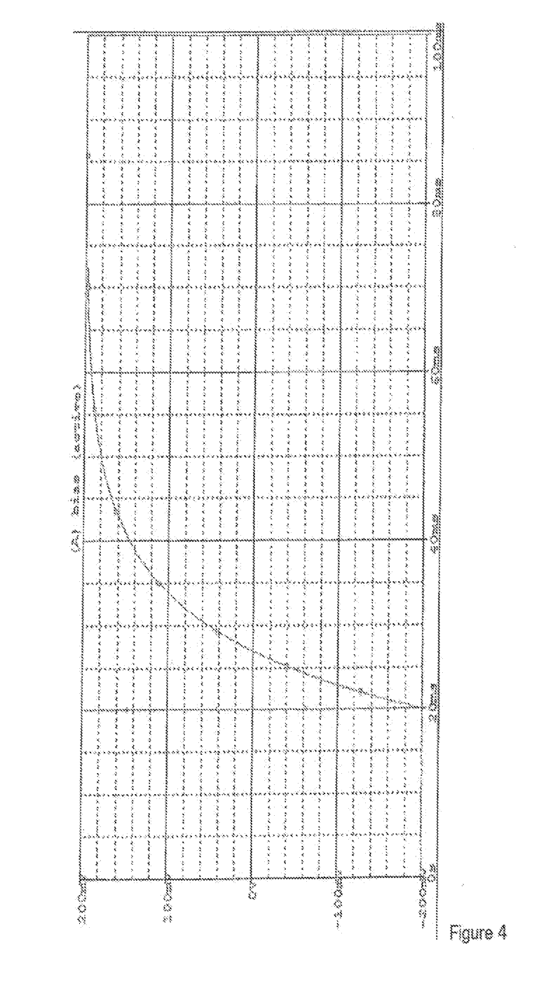

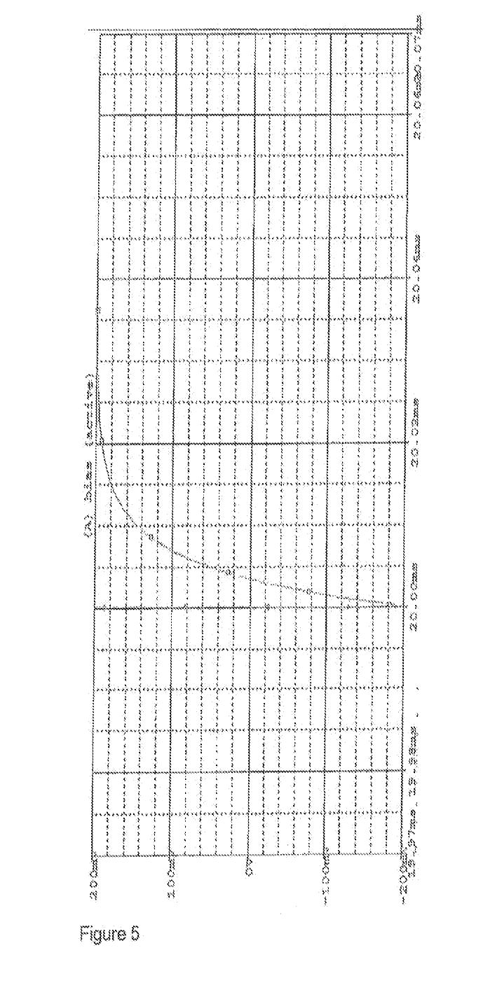

FIG. 4 represents a step response without a guard circuit. It takes around 80 ms until the impedance-converted signal can follow the actual signal. FIG. 5 represents the same experimental arrangement as FIG. 4, but with an optimally configured guard circuit (guarding and layout as well as optimized guard amplifier V2). In this arrangement, the impedance-converted signal takes 50 μs to follow the actual signal.

In the measurement, a pH electrode of about 100 MΩ and a total guard capacitance of about 100 pF was used. With this arrangement, signals of much less than 0.5 ms can be measured very reliably and accurately. If the impedance of the electrode and the guard capacitances can be reduced, even much more rapid signals can be measured.

The measurement arrangement described in FIG. 3, consisting of a pH electrode 15, an input amplifier (impedance converter) 16 and a further amplifier (guard amplifier) 17 can also be used in arrangements of three or more electrodes together with potentiostatic, galvanostatic, dynamic or impedance-spectroscopic methods.

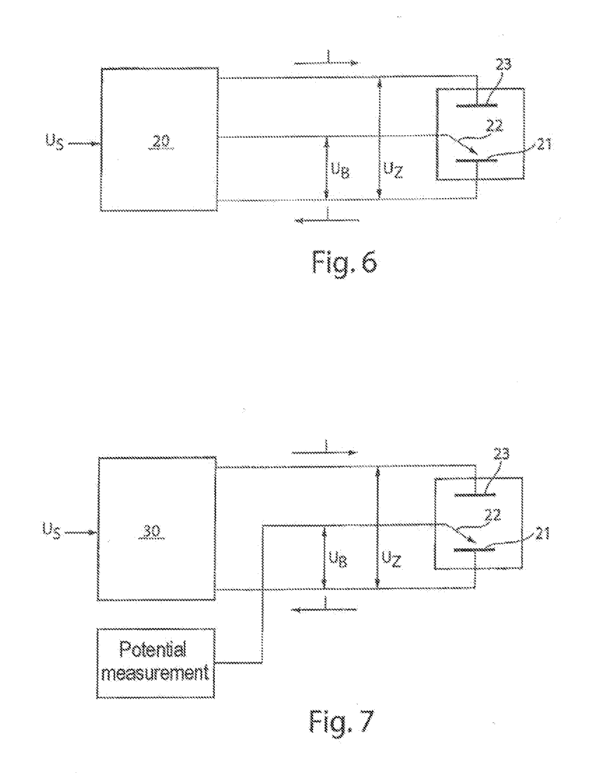

The arrangement for carrying out a potentiostatic method for measurement, deposition or dissolving is represented in FIG. 6. The arrangement comprises at least one potentiostat 20, at least one working electrode 21, at least one reference electrode 22 and at least one counter electrode 23. A reference variable U_{S} is designated, to which the controlled variable U_{B} is tracked with the aid of the manipulated variable U_{Z}. In this case, the current I at the working electrode 21 is observed.

The arrangement for carrying out a galvanostatic method, which is represented in FIG. 7, comprises at least one galvanostat 30, at least one working electrode 21, at least one reference electrode 22 and at least one counter electrode 23. A reference variable U_{S} is designated, which the controlled variable I is tracked with the aid of the manipulated variable U_{Z}. In this case, the potential at the reference electrode 22 is observed.

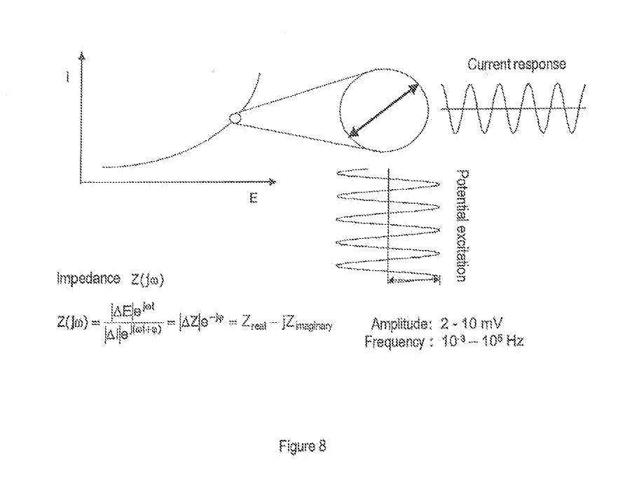

In the scope of the present invention, methods are dynamic when, in potentiostatic methods, the reference variable U_{S} changes by more than 5 mV/s at least at one point or, in galvanostatic methods, the observation variable changes by more than 5 mV/s at least at one point. Methods are impedance-spectroscopic when, in potentiostatic methods, at least at one working point the voltage is modulated with a frequency of from 10⁻³ Hz to 10⁵ Hz and an amplitude of up to about 50 mV. A sinusoidal signal shape is typically selected, although other modulations may also be used. The AC impedance Z(jw) can be calculated from the current response and the voltage modulation (FIG. 8).

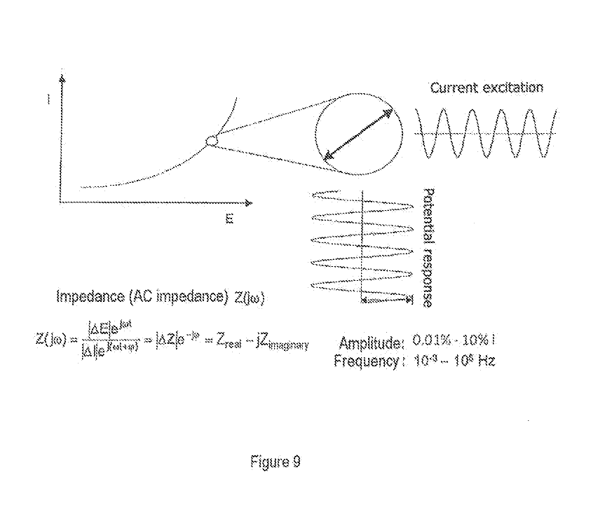

Methods are impedance-spectroscopic when, in galvanostatic methods, at least at one working point the current is modulated with a frequency of from 10⁻³ Hz to 10⁵ Hz and an amplitude of up to about 10% of the current at the working point. A sinusoidal signal shape is typically selected, although other modulations may also be used. The AC impedance Z(jw) can be calculated from the voltage response and the current modulation (FIG. 9).

$$Z ( j ω ) = \frac{\vert Δ E \vert {e}^{j ω t}}{\vert Δ I \vert {e}^{j ( ω t + ϕ )}} = \vert Δ Z \vert {e}^{- j ϕ} = {Z}_{real} - {jZ}_{imaginary}$$

Particularly in potentiostatic applications, the delay time/phase rotation of the measurement circuit is crucial for being able to carry out oscillation-free measurements. It is therefore necessary to keep the delay time/phase rotation, which is caused by the reference electrode, as small as possible in order to be able to make exact measurements. This is even more important in impedance-spectroscopic methods, since even very small phase shifts can have large repercussions on the calculation of the real and imaginary impedances.

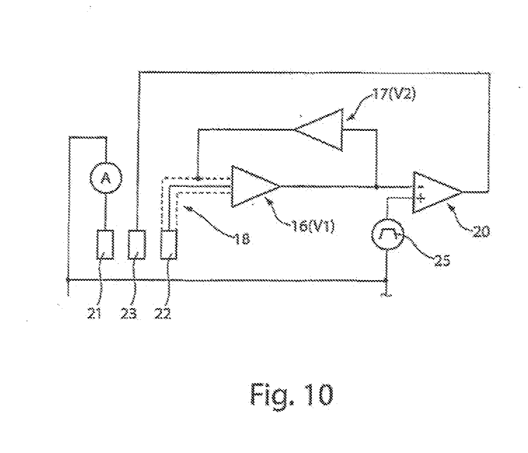

FIG. 10 represents in a simplified way a potentiostatic arrangement having a pH electrode as a reference electrode 22, having an impedance converter 16 (V1), a guard amplifier 17 (V2), guarding 18, a potentiostat 20 and a function generator 25.

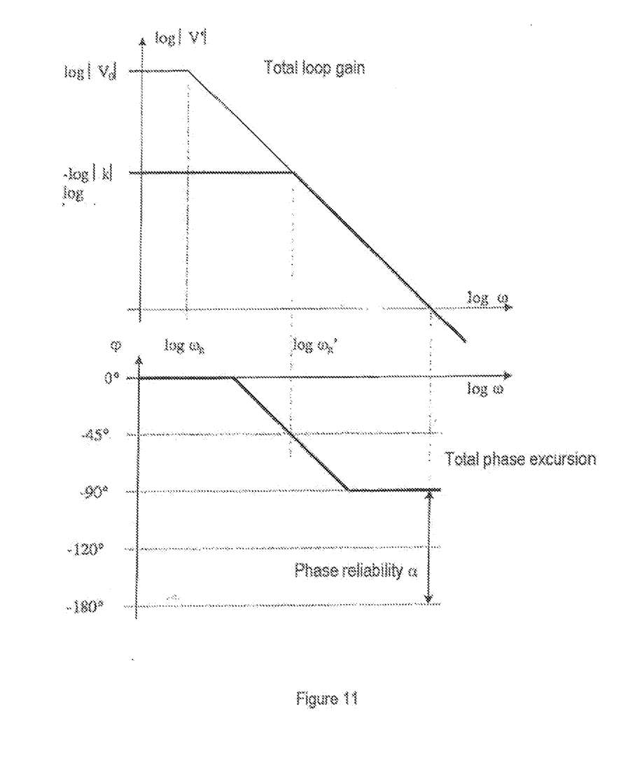

It is necessary to ensure that the entire arrangement satisfies the stability criteria of a control loop. The frequency compensation of the potentiostat 20 should be adjusted in such a way that there is still sufficient phase margin (at least 66°, preferably 90°), as represented as an example in FIG. 11.

The invention will be described below with the aid of an example of a practical application, namely the determination of organic additives in plating tanks by means of CVS (cyclic voltammetry stripping). There are several methods, all being based on a substantially smaller amount of the sample to be studied being added to a particular amount of a base electrolyte. The pH of the sample therefore corresponds to a good approximation to the pH of the base electrolyte. With this method, it is possible to determine the organic additives in the sample.

Cover layer diagrams are used to assess the quality of the working electrode and the status of the measurement cell. Typically, 1 N sulfuric acid is used for this.

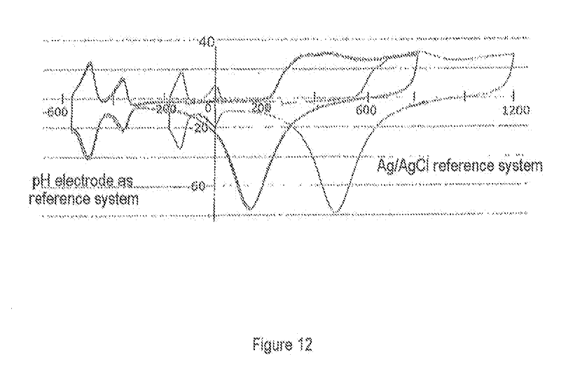

FIG. 12 represents a cover layer diagram in 1 n H₂SO₄ with 1 V/s and plating 2 mm working electrode, which was recorded once with a conventional Ag/AgCl reference electrode and once with a glass pH electrode as reference electrode with an impedance converter V1 and guard circuit V2. The rate of advance in both measurements was 1 V/s.

This example shows that the diagram when using a pH electrode is shifted by 385 mV in the negative direction relative to an Ag/AgCl reference system. Start and end potential CV sweeps were adapted accordingly.

It is readily possible to achieve rates of advance of 1 V/s or more.

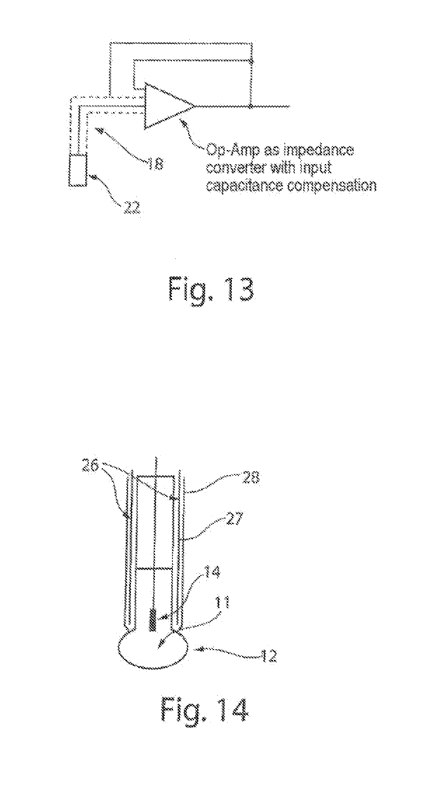

The amplifiers 16 (V1) and 17 (V2) may also be combined into one amplifier, so long as this amplifier has the necessary properties of V1 and V2. This is a variant of the arrangement of FIG. 3 and is represented as an example in FIG. 13.

The pH electrodes may also have their own guarding 26, as represented in a simplified way in FIG. 14. The guarding is insulated from the outer casing 27 of the pH electrode and must not have any contact with the liquid to be measured. Typically, a further glass tube is fused over the guarding 26. The guarding 26 consists of an electrically conductive material, which may be solid or liquid.

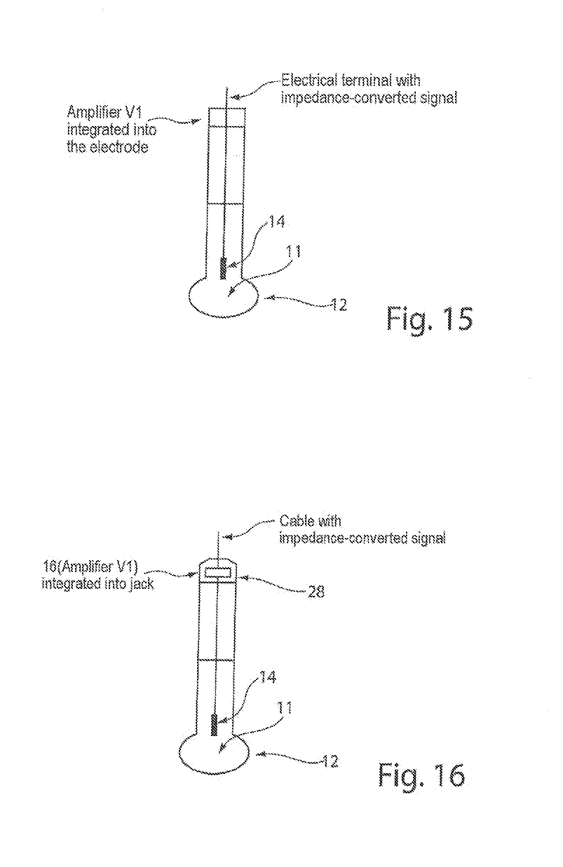

If the amplifier V1 is integrated directly into the pH electrode, the amplifier V2 may be obviated so long as the pH electrode has no guarding. For this arrangement, which is represented in FIG. 15, a multistranded cable is necessary since the supply voltage needs to be delivered to the amplifier V1. In addition, a line is necessary for the measurement signal.

It is also possible to integrate the amplifier V1 into the connection jack 28 of the pH electrode. If the jack 28 and the pH electrode have no guarding, the amplifier V2 may be obviated. This arrangement is represented in a simplified way in FIG. 16. Here again, it is necessary to deliver the supply voltage to the amplifier 16 (V1) via the cable.

1. A method for electrochemical analysis and deposition, the method comprising the steps of:
(a) providing a reference system, the reference system including at least one working electrode, one mating electrode and one reference electrode, wherein the reference electrode is a pH electrode which comprises an impermeable membrane, the reference system further including an input amplifier VI for the pH electrode having a high input impedance;
(b) using the reference system in one of the following three ways:
i) delivering the signal of the pH electrode to the input amplifier V1 via a cable and providing a further amplifier V2, which is used to compensate for the detrimental effects of the guarding and of the cable and of the measurement layout, or
ii) integrating the amplifier V1 as an impedance converter into the pH electrode and providing a further amplifier V2 which is used to compensate for the detrimental effects of the guarding of the pH electrode, into which the pH electrode is integrated, or
iii) integrating the amplifier V1 as an impedance converter into the jack of the pH electrode and providing a further amplifier V2, which is used to compensate for the detrimental effects of the guarding of the pH electrode, which is integrated into the jack of the pH electrode.

2. The method as claimed in claim 1, wherein the pH electrode is one of a glass electrode and an enamel electrode.

3. The method as claimed in claim 2, wherein the glass electrode comprises an internal buffer having a higher pH than the solution to be measured.

4. The method as claimed in claim 1, wherein the input impedance of the input amplifier V1 is more than 10¹¹Ω.

5. The method as claimed in claim 1, wherein the input current of the input amplifier V1 is less than 10 pA.

6. The method as claimed in claim 1, wherein the cutoff frequency of the input amplifier V1 is more than 1 MHz.

7. The method as claimed in claim 1, wherein the further amplifier V2 has a cutoff frequency of at least 1 MHz.

8. The method as claimed in claim 1, wherein the further amplifier V2 can drive a capacitive load of more than 10 pF.

9. The method as claimed in claim 1, wherein one amplifier comprises the function of the input amplifier V1 as well as a further amplifier V2.

10. The method as claimed in claim 1 wherein said method is used in one of a dynamic, impedance-spectroscopic, potentiostatic or galvanostatic method.

11. The method as claimed in claim 1 wherein said method is used in the semiconductor industry and in printed circuit board manufacture.

12. The method as claimed in claim 1 in coating methods with changes in the coating methods shorter than 200 ms.

13. The method as claimed in claim 4 wherein the input impedance of the input amplifier V1 is more than 10¹²Ω.

14. The method as claimed in claim 5 wherein the input current of the input amplifier V1 is less than 1 pA.

15. The method as claimed in claim 14 wherein the input current of the input amplifier V1 is less than 200 fA.

16. The method as claimed in claim 6 wherein the cutoff frequency of the input amplifier V1 is more than 3.5 MHz.

17. The method as claimed in claim 16 wherein the cutoff frequency of the input amplifier V1 is more than 25 MHz.

18. The method as claimed in claim 7 wherein the further amplifier V2 has a cutoff frequency of at least 3.5 MHz.

19. The method as claimed in claim 18 wherein the further amplifier V2 has a cutoff frequency of at least 15 MHz.

20. The method as claimed in claim 8 wherein the further amplifier V2 can drive a capacitive load of more than 100 pF.

21. The method as claimed in claim 20 wherein the further amplifier V2 can drive a capacitive load of more than 1 nF.

22. The method as claimed in 12 wherein said method is used in coating methods with changes in the coating methods shorter than 100 ms.
